(19) United States
(12) Patent Application Publication
(10) Pub. No.: US 2020/0253164 A1
(43) Pub. Date: Aug. 13, 2020

(54) APPARATUS AND METHOD FOR A PET TOY HAND GUARD SYSTEM

(71) Applicant: MARIO J. MARIN, MURRIETA, CA (US)

(72) Inventor: MARIO J. MARIN, MURRIETA, CA (US)

(21) Appl. No.: 16/271,805

(22) Filed: Feb. 9, 2019

(51) Int. Cl. A01K 15/02

(52) U.S. Cl. CPC A01K 15/025

(57) ABSTRACT

The embodiments disclose an apparatus and method for a pet toy hand guard system including creating a pet toy hand guard, coupling an inside toy hand guard handle to the pet toy hand guard, coupling a pet toy to the pet toy hand guard, using the pet toy hand guard with the pet toy coupled to the pet toy hand guard system encapsulates and protects the hand from a potential/accidental bite, playing with the user's pet with a rope or other pet toy coupled to the hand guard, wherein the user's hand is protected, and gauging the user pet's actions using sensor modules integrated into the pet toy hand guard for determining a level of pet actions from playful to ferocious to violent. The pet toy hand guard handle allows better gripping of pet toy while playing with the pet.

### BACKGROUND

Pet owners enjoy playing with their pets with a variety of pet toys. Some pet toys include ropes or other tugging toys where the pet bites one end of the, for example, rope and the pet owner holds the other end. Some pet owners are injured when their pet may become over-excited and may bite the unprotected pet owner's hand holding the rope.

### BRIEF DESCRIPTION OF THE DRAWINGS

FIG. 1 shows a block diagram of an overview of an apparatus and method for a pet toy hand guard system of one embodiment.

FIG. 2 shows for illustrative purposes only an example of a first pet toy hand guard system coupled with a first pet toy of one embodiment.

FIG. 3 shows for illustrative purposes only an example of a first pet toy hand guard system with a second pet toy of one embodiment.

FIG. 4 shows for illustrative purposes only an example of a first pet toy hand guard system with a third pet toy of one embodiment.

FIG. 5 shows for illustrative purposes only an example of a user hand holding the first pet toy hand guard with the first pet toy cutaway top view of one embodiment.

FIG. 6 shows for illustrative purposes only an example of a user hand holding the first pet toy hand guard with the first pet toy cutaway side view of one embodiment.

FIG. 7 shows for illustrative purposes only an example of a user pet playing with the first pet toy cutaway side view of one embodiment.

FIG. 8 shows for illustrative purposes only an example of a first pet toy hand guard system interior view of one embodiment.

FIG. 9 shows for illustrative purposes only an example of pet action integrated sensors modules of one embodiment.

FIG. 10 shows for illustrative purposes only an example of a first pet toy hand guard rear perspective view of one embodiment.

FIG. 11A shows for illustrative purposes only an example of a second pet toy hand guard system interior view of one embodiment.

FIG. 11B shows for illustrative purposes only an example of a strain gauge sensor system interior view of one embodiment.

FIG. 12 shows for illustrative purposes only an example of a strain gauge sensor system cross section of one embodiment.

FIG. 13 shows for illustrative purposes only an example of a textured finger grip pet toy hand guard handle of one embodiment.

FIG. 14 shows for illustrative purposes only an example of human hand styled pet toy hand guard of one embodiment.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the embodiments.

### General Overview:

It should be noted that the descriptions that follow, for example, in terms of an apparatus and method for a pet toy hand guard system is described for illustrative purposes and the underlying system can apply to any number and multiple types an apparatus and method for a pet toy hand guard system. In one embodiment of the present invention, the pet toy hand guard can be configured using a plastic, other material that is sturdy, safe for dogs/animals and humans, or metal fabrication material. The apparatus and method for a pet toy hand guard system can be configured to include at least one rope pet toy and can be configured to include other types of tugging pet toys using the embodiments.

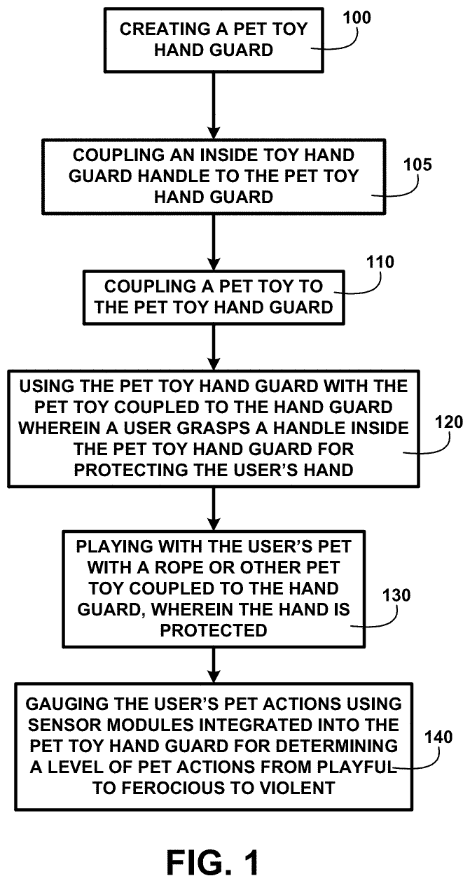

FIG. 1 shows a block diagram of an overview of an apparatus and method for a pet toy hand guard system of one embodiment. FIG. 1 shows the apparatus and method for a pet toy hand guard system including creating a pet toy hand guard 100. The creating a pet toy hand guard 100 can include fabricating the pet toy hand guard using a durable plastic or metal material. Coupling an inside toy hand guard handle to the pet toy hand guard 105 for allowing a user to grasp the inside pet toy hand guard handle for securing a firm grip on the pet toy hand guard. Coupling a pet toy to the pet toy hand guard 110 provides a pet owner and handler with an apparatus for tugging play with their pet. Using the pet toy hand guard with the pet toy coupled to the hand guard wherein a user grasps a pet toy hand guard handle inside the pet toy hand guard for protecting the user's hand 120. The inside pet toy hand guard handle will also allow for a better grip of a pet toy while playing with pet and keep or minimize any type of injury to hand, palm, and fingers. The pet toy hand guard will encapsulate and protect the hand from a potential/accidental bite while playing with your pet. Playing with the user's pet with a rope or other pet toy coupled to the hand guard, wherein the hand is protected 130. Gauging the user's pet actions using sensor modules integrated into the pet toy hand guard for determining a level of pet actions from playful to ferocious to violent 140. A pet's actions may change characteristics if they are sick or suffering from a condition. Gauging the user's pet actions may provide the pet owner with an indication that their pet may be sick or suffering from a condition and may also alert the pet owner that the pet is more aggressive or violent than the pet owner was aware of and may need to seek advice from a veterinarian or trainer of one embodiment.

### DETAILED DESCRIPTION

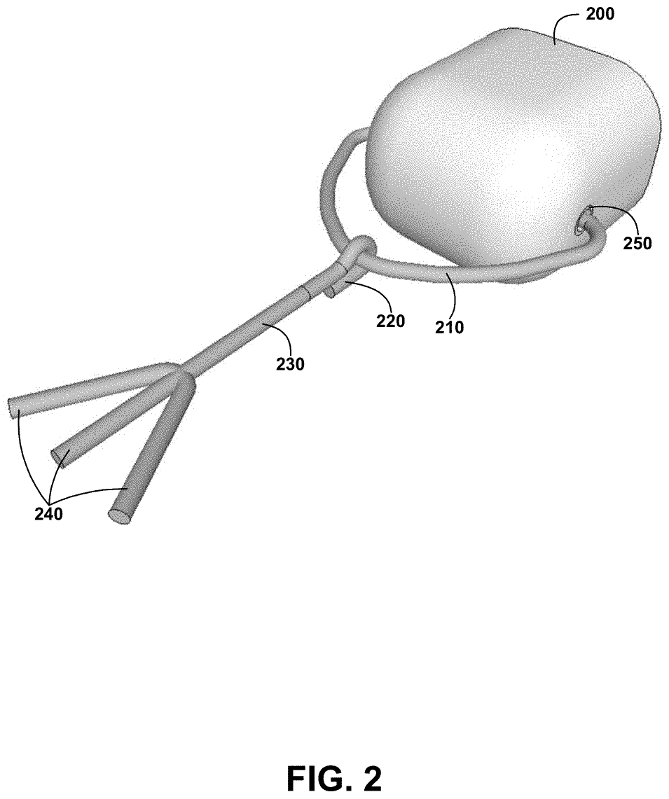

FIG. 2 shows for illustrative purposes only an example of a first pet toy hand guard system coupled with a first pet toy of one embodiment. FIG. 2 shows a pet toy hand guard 200 with a coupled pet toy attachment rope 210. The pet toy attachment rope 210 is coupled to the pet toy hand guard 200 through a pet toy hand guard handle opening 250. A pet toy coupling device 220 is used to couple a pet toy extension 230 with a 3-section pet toy 240 to the pet toy attachment rope 210. The user's pet can bite a pet toy including the 3-section pet toy 240 and tug the 3-section pet toy 240 away from the pet toy hand guard 200 and from side to side of one embodiment.

A First Pet Toy Hand Guard System with a Second Pet Toy:

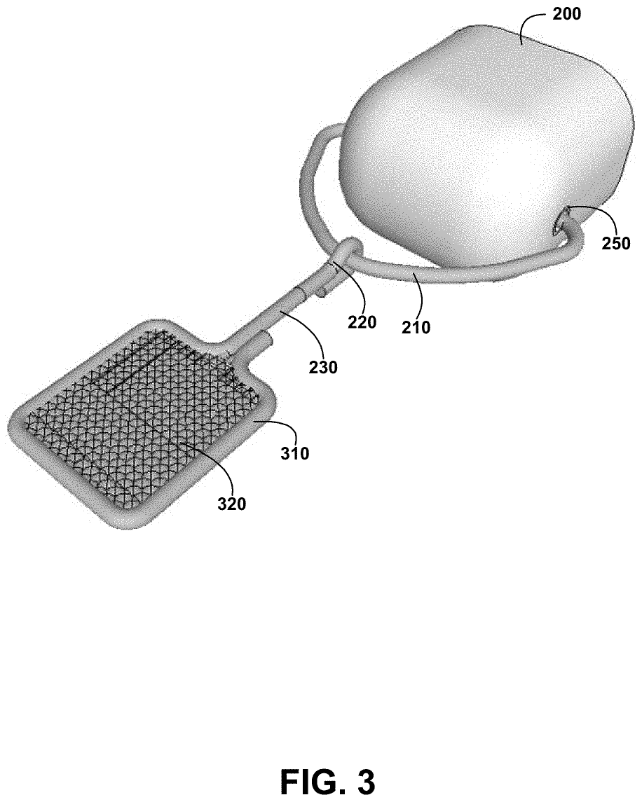

FIG. 3 shows for illustrative purposes only an example of a first pet toy hand guard system with a second pet toy of one embodiment. FIG. 3 shows a pet toy hand guard 200 with a coupled pet toy attachment rope 210. The pet toy attachment rope 210 is coupled to the pet toy hand guard 200 through a pet toy hand guard handle opening 250. A pet toy coupling device 220 is used to couple a pet toy extension 230 with a rectangular bite frame 310 with a rectangular bite frame mesh 320 to the pet toy attachment rope 210 of one embodiment.

A Pet Toy Hand Guard System with a Third Pet Toy:

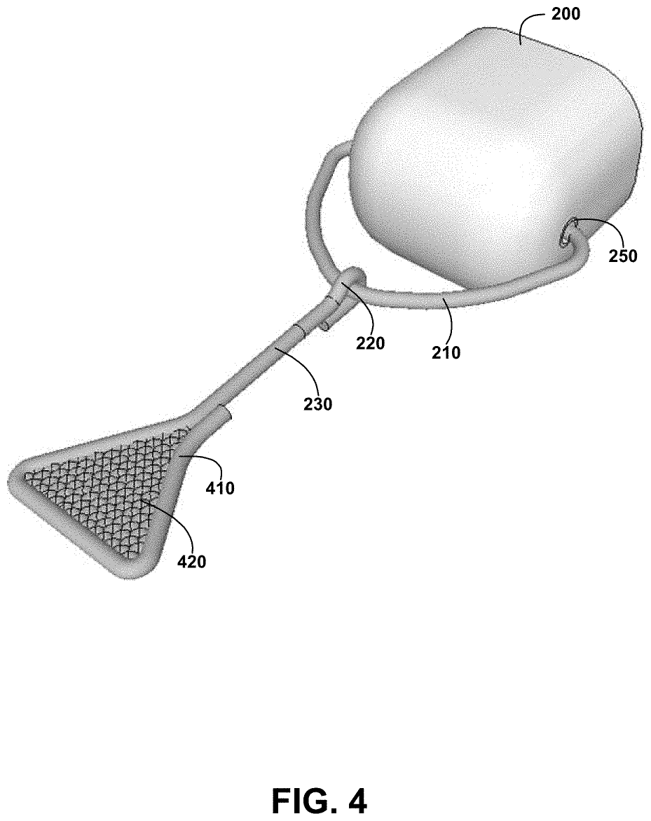

FIG. 4 shows for illustrative purposes only an example of a first pet toy hand guard system with a third pet toy of one embodiment. FIG. 4 shows a pet toy hand guard 200 with a coupled pet toy attachment rope 210. The pet toy attachment rope 210 is coupled to the pet toy hand guard 200 through a pet toy hand guard handle opening 250. A pet toy coupling device 220 is used to couple a pet toy extension 230 with a triangular bite frame 410 with a triangular bite frame mesh 420 to the pet toy attachment rope 210 of one embodiment.

A User Hand Holding the First Pet Toy Hand Guard with the First Pet Toy Cutaway Top View:

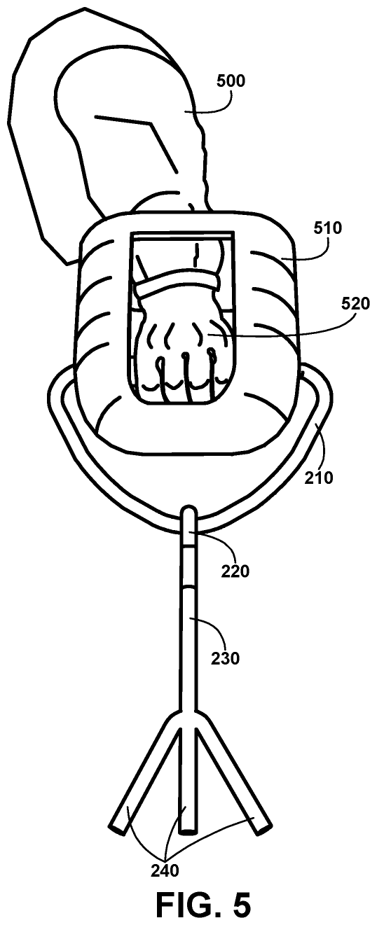

FIG. 5 shows for illustrative purposes only an example of a user hand holding the first pet toy hand guard with the first pet toy cutaway top view of one embodiment. FIG. 5 shows the pet toy attachment rope 210, pet toy coupling device 220, pet toy extension 230, and the 3-section pet toy 240 coupled to the pet toy hand guard with a top cut away for illustration purposes 510. A pet owner's arm 500 is shown extending a pet owner's hand inside the pet toy hand guard 200. Showing inside the pet toy hand guard 200 a pet owner's hand grasping a pet toy hand guard handle 520 of one embodiment.

A User Pet Playing with the First Pet Toy Cutaway Side View:

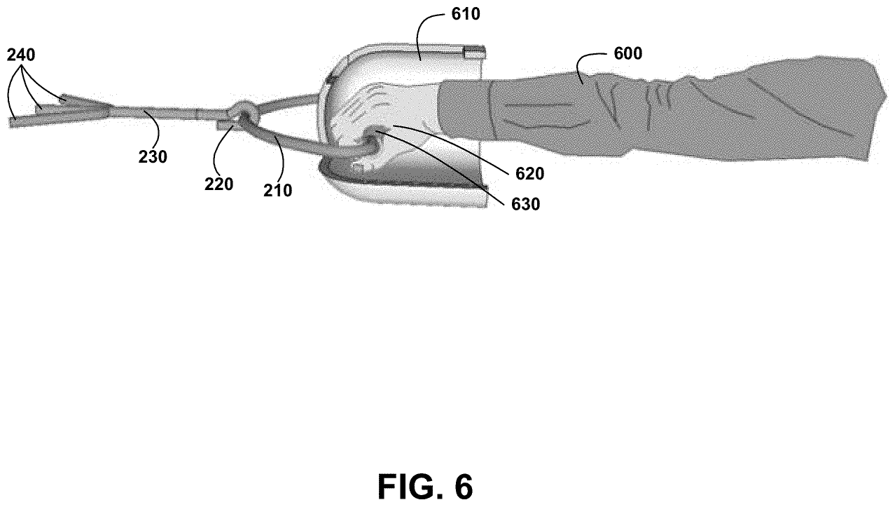

FIG. 6 shows for illustrative purposes only an example of a user hand holding the first pet toy hand guard with the first pet toy cutaway side view of one embodiment. FIG. 6 shows the pet toy attachment rope 210, pet toy coupling device 220, pet toy extension 230, the 3-section pet toy 240, and a pet toy hand guard handle 630. FIG. 6 also shows a side view of the pet toy hand guard with a side view cut away for illustration purposes 610 and a side view of the pet owner's arm extending into the pet toy hand guard 600 up to the wrist. A pet owner's hand grasping the pet toy hand guard handle 620 shows how a pet owner can firmly control the pet toy hand guard 200 of FIG. 2 of one embodiment.

### A First Pet Toy Hand Guard System Interior View:

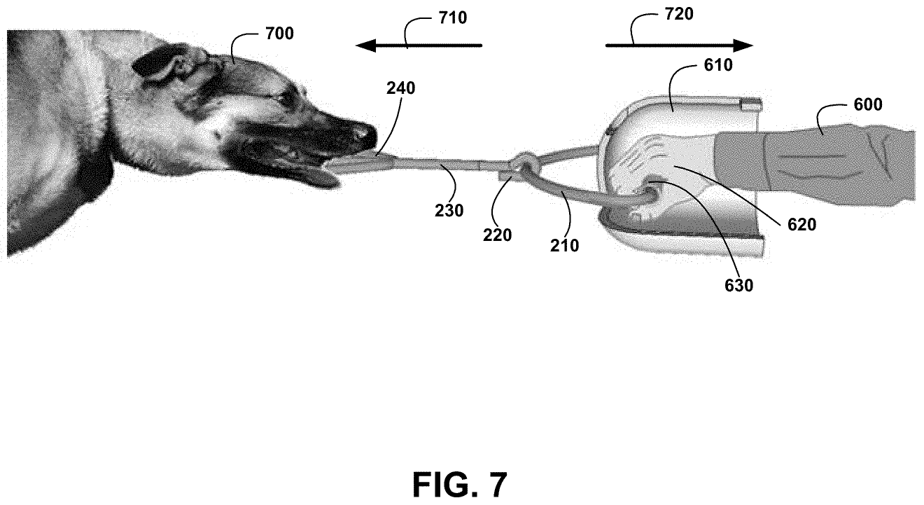

FIG. 7 shows for illustrative purposes only an example of a user pet playing with the first pet toy cutaway side view of one embodiment. FIG. 7 shows the pet toy attachment rope 210, pet toy coupling device 220, pet toy extension 230, the 3-section pet toy 240, and the pet toy hand guard handle 630. The a side view of the pet toy hand guard with a side view cut away for illustration purposes 610 shows the side view of the pet owner's arm extending into the pet toy hand guard 600 and the pet owner's hand grasping the pet toy hand guard handle 620. A pet owner's pet in this example a dog is biting the 3 section pet toy 700 and wherein the dog is pulling the 3 section pet toy towards itself 710 and the pet owner is pulling in the opposite direction 720 of one embodiment.

### Pet Action Integrated Sensors Modules:

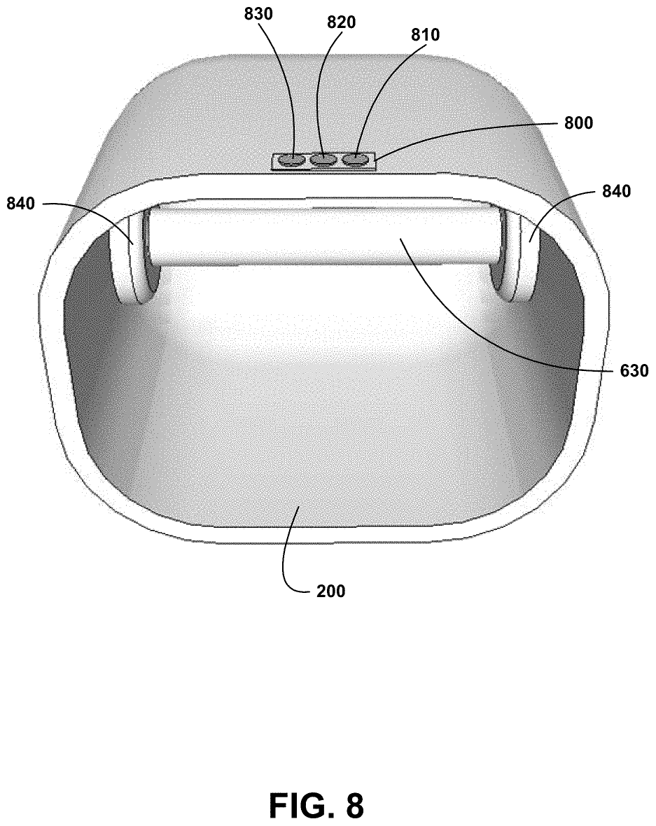

FIG. 8 shows for illustrative purposes only an example of a first pet toy hand guard system interior view of one embodiment. FIG. 8 shows the pet toy hand guard 200 coupled with the pet toy hand guard handle 630 are configured for ambidextrous use. At least one integrated sensor module 800 compartment coupled to the pet toy hand guard 200 is also electronically and mechanically coupled to the pet toy hand guard handle 630. A pet pulling and thrashing from side to side with the pet toy activates the at least one integrated sensor module 800. The at least one integrated sensor module 800 is configured to measure the pulling force and thrashing magnitude of force and frequency.

The at least one integrated sensor module 800 includes in the compartment at least one rechargeable battery, a digital processor, a digital memory device and a near-field transceiver with a WIFI connection capable communication device. The at least one integrated sensor module 800 compartment includes a playful sensing gauge LED light 810, a ferocious sensing gauge LED light 820, and a violent sensing gauge LED light 830 to alert the pet owner of the pet action level. A pet toy hand guard handle reinforcing module 840 with at least one stress sensor module configured for determine an amount of stress being applied on the pet toy hand guard of one embodiment.

### A First Pet Toy Hand Guard Side View:

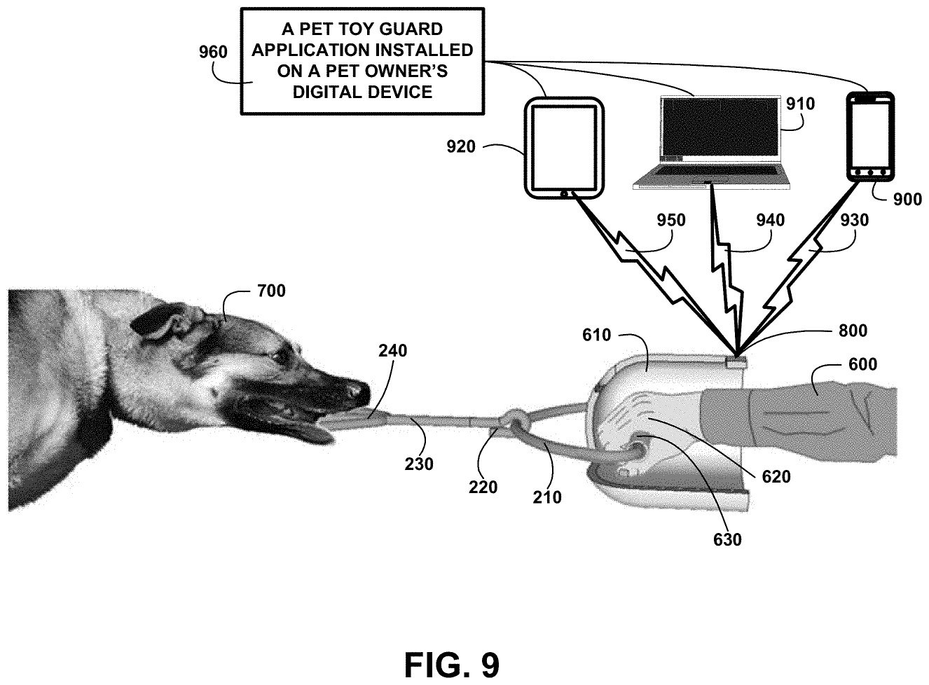

FIG. 9 shows for illustrative purposes only an example of pet action integrated sensors modules of one embodiment. FIG. 9 shows the side view of the pet toy hand guard with a side view cut away for illustration purposes 610. FIG. 9 also shows the pet toy attachment rope 210, pet toy coupling device 220, pet toy extension 230 and the 3-section pet toy 240. FIG. 9 shows a side view of the pet owner's arm extending into the pet toy hand guard 600 to a pet toy hand guard handle 630 and with a pet owner's hand grasping the pet toy hand guard handle 620. A pet owner's pet in this example is a dog biting and pulling on the 3 section pet toy 700. An integrated sensor module compartment coupled to pet toy hand guard handle 800 illuminate an LED light which can indicate a playful, ferocious or violent level of play from the pet.

A pet toy hand guard application installed on a pet owner's digital device 960 can receive from the at least one integrated sensor module 800, near-field transceiver, a WIFI connection capable communication device, a play level alert, and a graphic and numeric determined strain level indicator. A pet toy hand guard application installed on a pet owner's digital device 960, wherein the sensor gauging signal is received using the WIFI connectivity of the pet owner's digital device and displayed using the pet toy hand guard application including an audible alert differing for each pet action level determined. The pet toy hand guard application play level display on for example a pet owner's smart phone 900 can be forwarded to for example a dog trainer or veterinarian for advice to the pet owner on behavioral training methods.

A sensor gauging signal can be transmitted to the pet owner's smart phone 930, a pet owner's computer including a desktop and laptop computer 910 and a pet owner's digital tablet 920. A pet owner may elect to record and store each pet action level determined on for example the pet owner's computer 940 or the pet owner's digital tablet 950 to review the progression of training using the pet toy hand guard 200 of one embodiment.

### A First Pet Toy Hand Guard Rear Perspective View:

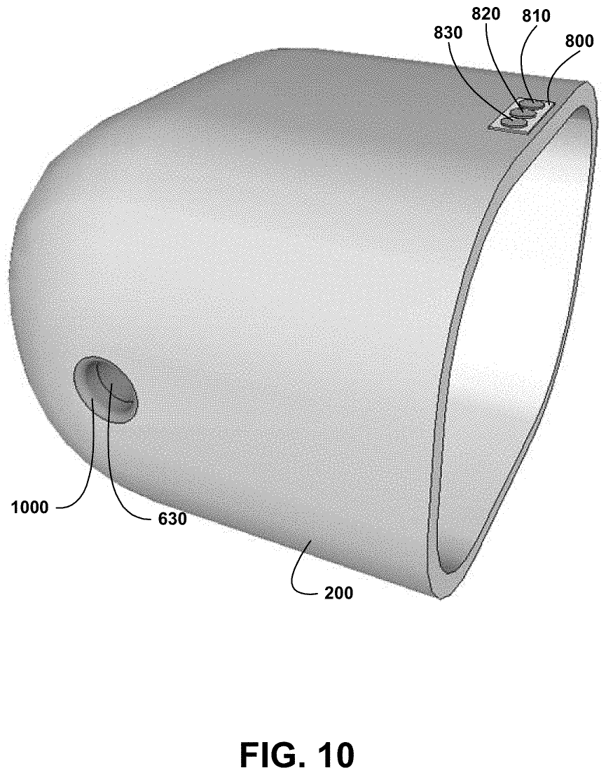

FIG. 10 shows for illustrative purposes only an example of a first pet toy hand guard rear perspective view of one embodiment. FIG. 10 shows a pet toy hand guard 200 with an integrated sensor module compartment coupled to pet toy hand guard handle 800. The integrated sensor module compartment includes the playful sensing gauge LED light 810, ferocious sensing gauge LED light 820 and violent sensing gauge LED light 830. The pet toy hand guard handle 630 includes a pet toy hand guard handle terminus natural curve 1000 at both ends which also allows pulling of the rope to pass through tube without cutting or abrasion of one embodiment.

### Second Pet Toy Hand Guard System Interior View:

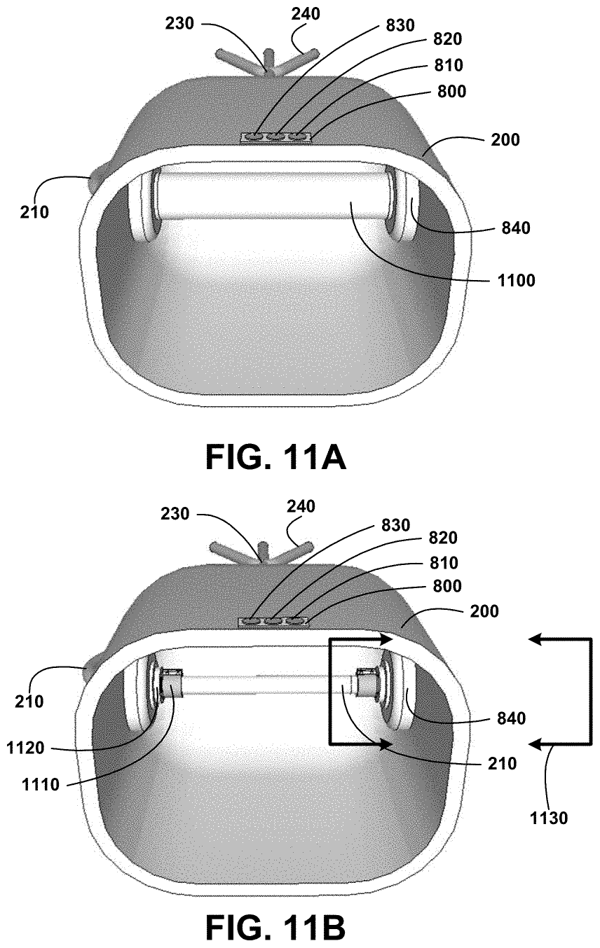

FIG. 11A shows for illustrative purposes only an example of a second pet toy hand guard system interior view of one embodiment. FIG. 11A shows the pet toy hand guard 200, pet toy attachment rope 210, pet toy extension 230, and 3 section pet toy 240. FIG. 11A further shows the integrated sensor module compartment coupled to pet toy hand guard handle 800 with the playful sensing gauge led light 810, ferocious sensing gauge led light 820, and violent sensing gauge led light 830. Seen in the interior view is the pet toy hand guard handle reinforcing module 840 with at least one stress sensor module configured for determine an amount of stress being applied on the pet toy hand guard of a second pet toy hand guard system 1100 of one embodiment.

### Strain Gauge Sensor System Interior View:

FIG. 11B shows for illustrative purposes only an example of a strain gauge sensor system interior view of one embodiment. FIG. 11B shows the pet toy hand guard 200, pet toy attachment rope 210, pet toy extension 230, 3 section pet toy 240, integrated sensor module compartment coupled to pet toy hand guard handle 800, playful sensing gauge led light 810, ferocious sensing gauge led light 820, violent sensing gauge led light 830, and the pet toy hand guard handle reinforcing module 840 with at least one stress sensor module configured for determine an amount of stress being applied on the pet toy hand guard. The interior view has the pet toy hand guard handle not shown to illustrate a strain gauge sensor rope gripper 1110 and sensor housing 1120 coupled to both ends of the pet toy hand guard handle and a cross section indicator 1130 of one embodiment.

### Strain Gauge Sensor System Cross Section:

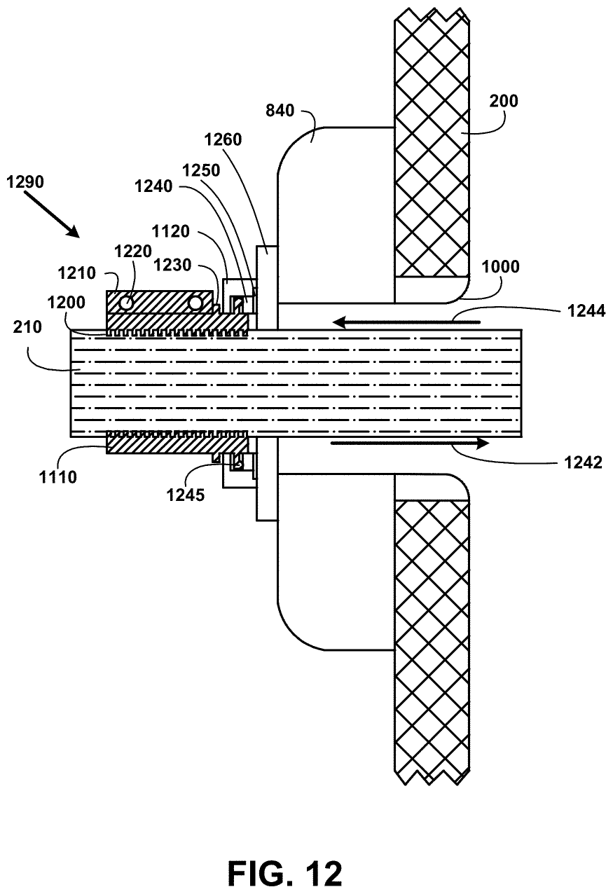

FIG. 12 shows for illustrative purposes only an example of a strain gauge sensor system cross section of one embodiment. FIG. 12 shows a strain gauge sensor system cross section 1290 showing the pet toy hand guard 200, pet toy attachment rope 210, pet toy hand guard handle terminus natural curve 1000, and pet toy hand guard handle reinforcing module 840 with at least one stress sensor module configured for determine an amount of stress being applied on the pet toy hand guard. The strain gauge sensor rope gripper 1110 is shown coupled to the pet toy attachment rope 210 using strain gauge sensor rope gripper ribs 1200 to prevent slippage through the strain gauge. A strain gauge sensor rope gripper bracket 1210 allows tightening of the gripper and two strain gauge sensor rope gripper bracket bolt holes 1220 accept bolts to perform the tightening. A strain gauge sensor rope gripper stop 1230 is used to stop to prevent the stain gauge from being pulled out of the pet toy hand guard. The sensor housing 1120 contains at least one strain gauge sensor 1240 which is held in place using a sensor housing cover 1250.

A strain gauge mounting plate 1260 is used to mount the strain gauge assembly to the pet toy hand guard handle reinforcing module 840. A strain gauge press ring 1245 applies pressure to the at least one strain gauge sensor 1240 when the pet pulling rope is pull outward 1242. The strain gauge press ring 1245 releases pressure to the at least one strain gauge sensor 1240 when the pet pulling rope is pulled inward from the other side 1244. A pet side to side head thrashing creates strain that alternates the strain from one side to another. A pet pulling straight back from pet toy hand guard creates strain on both sides of one embodiment.

### A Textured Finger Grip Pet Toy Hand Guard Handle:

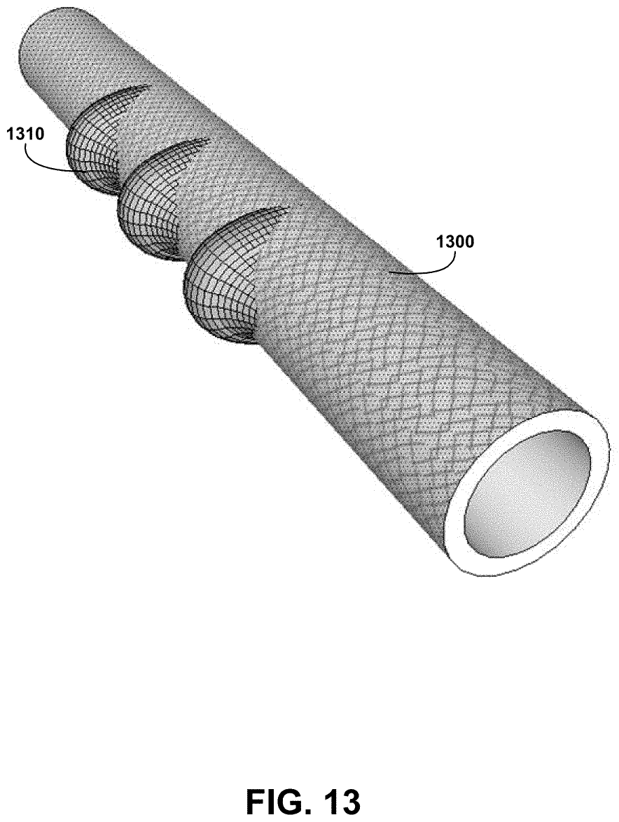

FIG. 13 shows for illustrative purposes only an example of a textured finger grip pet toy hand guard handle of one embodiment. FIG. 13 shows a textured finger grip pet toy hand guard handle 1300 with a plurality of an integrated raised finger grip 1310. The textured surface of the textured finger grip pet toy hand guard handle 1300 and each integrated raised finger grip 1310 assist the user in maintaining a firm grip on the pet toy hand guard handle 630 of FIG. 6. The textured finger grip pet toy hand guard handle 1300 and pet toy hand guard handle 630 of FIG. 6 referred to here as an inside pet toy hand guard handle will also allow for better grip of the pet toy hand guard apparatus while playing with pet and keep or minimizing any type of injury to hand, palm, and fingers. The pet toy hand guard will encapsulate and protect the hand from a potential/accidental bite while playing with your pet of one embodiment.

### Human Hand Styled Pet Toy Hand Guard:

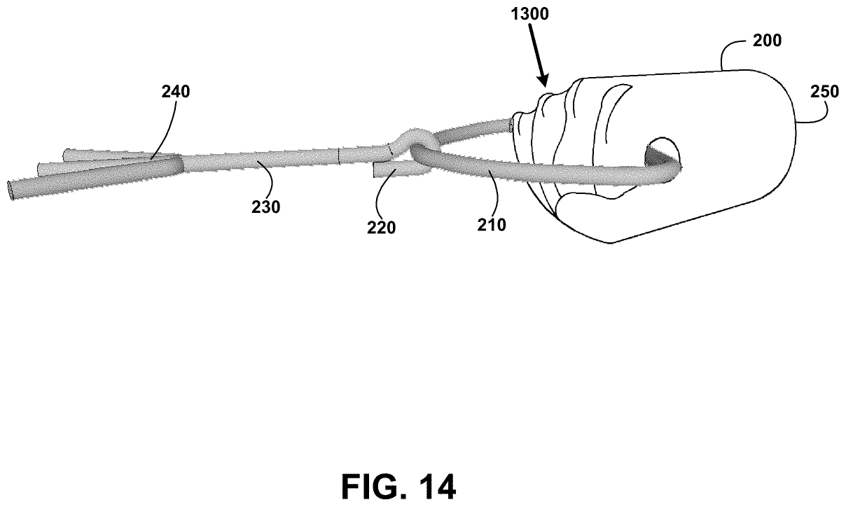

FIG. 14 shows for illustrative purposes only an example of human hand styled pet toy hand guard of one embodiment. FIG. 14 shows a pet toy hand guard 200 with the pet toy attachment rope 210, pet toy coupling device 220, pet toy extension 230, and 3 section pet toy 240 coupled to the pet toy hand guard 200. The pet toy hand guard 200 in one embodiment can be molded to create a human hand styled pet toy hand guard 1400. The human hand styled pet toy hand guard 1300 includes the pet toy hand guard handle opening 250 and is used by the user inserting a hand and grasping the pet toy hand guard handle 520 of FIG. 5 including the textured finger grip pet toy hand guard handle 1300 of FIG. 13. The human hand styled pet toy hand guard 1400 provides reinforcement to the training of don't bite the hand that feeds you of one embodiment.

The foregoing has described the principles, embodiments and modes of operation of the embodiments. However, the embodiments should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed is:

1. A method, comprising:
creating a pet toy hand guard;
coupling an inside toy hand guard handle to the pet toy hand guard;
coupling a pet toy to the pet toy hand guard;
using the pet toy hand guard with the pet toy coupled to the hand guard wherein a user grasps the inside pet toy hand guard handle for securing a firm grip on the pet toy hand guard;
playing with the user's pet with a rope or other pet toy coupled to the hand guard, wherein the hand is protected from a potential bite; and
gauging the user's pet actions using sensor modules integrated into the pet toy hand guard for determining a level of pet actions from playful to ferocious to violent.

2. The method of claim 1, wherein creating a pet toy hand guard includes fabricating a hand guard shield using plastic, other material that is sturdy, safe for dogs/animals and humans, metal or other rigid material to protect a pet owner and handler from injury while working with the pet.

3. The method of claim 1, further comprising using a pet toy attachment rope coupled to the pet toy hand guard through a pet toy hand guard handle opening and the pet toy attachment rope is coupled to a pet toy coupling device coupled to a pet toy extension.

4. The method of claim 1, further comprising using a pet toy including a 3-section pet toy.

5. The method of claim 1, further comprising using a pet toy including a rectangular bite frame with a rectangular bite frame mesh.

6. The method of claim 1, further comprising using a pet toy including a triangular bite frame with a triangular bite frame mesh.

7. The [device] of claim 1, further comprising using sensor modules integrated into the pet toy hand guard including at least one strain gauge at both terminuses of the pet toy hand guard handle.

8. The method of claim 1, further comprising using a pet toy hand guard application installed on a pet owner's digital device to receive a play level alert and a graphic and numeric determined strain level indicator from at least one integrated sensor module near-field transceiver with a WIFI connection capable communication device a play level alert and a graphic and numeric determined strain level indicator.

9. The method of claim 1, further comprising using sensor modules integrated into the pet toy hand guard including a compartment, at least one rechargeable battery, a digital processor, a digital memory device and a near-field transceiver with a WIFI connection capable communication device, a playful sensing gauge LED light, a ferocious sensing gauge LED light, a violent sensing gauge LED light and an audible alert.

10. The method of claim 1, further comprising using a pet toy hand guard application installed on a pet owner's digital device including a smart phone, a computer including a desktop and laptop computer and a pet owner's digital tablet for receiving, recording and storing to receive a play level alert and for forwarding play level alert data to a dog trainer or veterinarian for advice to the pet owner on behavioral training methods and review training progress.

11. An apparatus, comprising:
a pet toy hand guard for protecting a pet owner and handler hand while playing tugging activities with a pet;
an inside toy hand guard handle coupled to the pet toy hand guard;
at least one pet toy coupled to the pet toy hand guard for a pet to bite for playing tugging activities;
at least one integrated sensor module for determining a playing level by the pet owner; and
a pet toy hand guard application for receiving playing level alert from the at least one integrated sensor module on a pet owner digital device.

12. The apparatus of claim 11, further comprising a 3-section pet toy, a rectangular bite frame with a rectangular bite frame mesh, and a triangular bite frame with a triangular bite frame mesh.

13. The apparatus of claim 11, further comprising a pet owner's digital device including a smart phone, a computer including a desktop and laptop computer and a pet owner's digital tablet for receiving, recording and storing to receive a play level alert and for forwarding play level alert data to a dog trainer or veterinarian for advice to the pet owner on behavioral training methods and review training progress.

14. The apparatus of claim 11, further comprising at least one integrated sensor module coupled to the pet toy hand guard including a compartment, at least one rechargeable battery, a digital processor, a digital memory device and a near-field transceiver with a WIFI connection capable communication device, a playful sensing gauge LED light, a ferocious sensing gauge LED light, a violent sensing gauge LED light and an audible alert.

15. The apparatus of claim 11, further comprising a pet toy attachment rope coupled to the pet toy hand guard through a pet toy hand guard handle opening and the pet toy attachment rope is coupled to a pet toy coupling device coupled to a pet toy extension.

16. An apparatus, comprising:
a pet owner and handler hand protection device while playing tugging activities with a pet configured as a pet toy hand guard;
an inside toy hand guard handle coupled to the pet toy hand guard configured for allowing a pet owner and handle to maintain a firm grip of the pet toy hand guard;
a playing level determination device configured as at least one integrated sensor module coupled to the pet toy hand guard;
at least one pet toy coupled to the pet toy hand guard for the pet owner and handler to play with a pet; and
a pet owner digital device with a pet toy hand guard application installed for receiving playing level alert from the pet toy hand guard.

17. The apparatus of claim 16, further comprising the hand protection device configured as a pet toy hand guard configured to allow a pet owner to insert a hand to grasp the pet toy hand guard by an internal pet toy hand guard handle and can be configured with a curved front and a human fist and made of fabrication materials including plastic and metal.

18. The apparatus of claim 16, further comprising the playing level determination device configured as at least one integrated sensor module configured to include at least one strain gauge, a compartment, at least one rechargeable battery, a digital processor, a digital memory device and a near-field transceiver with a WIFI connection capable communication device, a playful sensing gauge LED light, a ferocious sensing gauge LED light, a violent sensing gauge LED light and an audible alert.

19. The apparatus of claim 16, further comprising at least one pet toy including a 3-section pet toy, a rectangular bite frame with a rectangular bite frame mesh, and a triangular bite frame with a triangular bite frame mesh for a pet to bite for tugging play with a pet owner and handler.

20. The apparatus of claim 16, further comprising the pet toy hand guard application configured for installation on the pet owner digital device including a smart phone, a desktop and laptop computer and a pet owner digital tablet for receiving, recording and storing to receive a play level alert and for forwarding play level alert data to a dog trainer or veterinarian for advice to the pet owner on behavioral training methods and review training progress.
